(19) United States
(12) Patent Application Publication
(10) Pub. No.: US 2014/0320961 A1
(43) Pub. Date: Oct. 30, 2014

(54) OPTICAL FILM

(71) Applicant: CRYSOPTIX KK, Tokyo (JP)

(72) Inventor: Alexander Lazarev, San Francisco, CA (US)

(73) Assignee: CRYSOPTIX KK, Tokyo (JP)

(21) Appl. No.: 14/159,391

(22) Filed: Jan. 20, 2014

Related U.S. Application Data
(60) Provisional application No. 61/758,268, filed on Jan. 29, 2013.

(51) Int. Cl. G02B 1/08; G02B 5/30

(52) U.S. Cl. CPC G02B 1/08; G02B 5/3083
USPC 359/489.07

(57) ABSTRACT

An optical film comprising a substrate having front and rear surfaces, and at least one solid optical retardation layer on the front surface of the substrate, wherein the solid optical retardation layer comprises organic rigid rod-like macromolecules based on 2,2′-disulfo-4,4′-benzidine terephthalamide or its salt of the general structural formula I. The solid optical retardation layer is an uniaxial positive A-type layer and is substantially transparent to electromagnetic radiation in the visible spectral range.

### CROSS REFERENCE TO RELATED APPLICATIONS

This application claims priority to and benefit of U.S. Provisional Application 61/758,268 filed Jan. 29, 2013 under 35 U.S.C. §119(e), the disclosure of which is incorporated herein by reference.

This application is related to U.S. patent application Ser. No. 12/426,326 filed on Apr. 24, 2008, entitled “Organic Compound, Optical Film and Method of Production Thereof”, the entire disclosure of which is incorporated by reference herein.

### FIELD OF THE INVENTION

The present invention relates to optical retardation films. The invention may be used as an optical element in liquid crystal display (LCD) devices, particularly as phase-shifting component of LCDs of both reflection and transmission type, and in any other field of science and technology where optical retardation films are applied.

### BACKGROUND OF THE INVENTION

Recent achievements in LCD technology has resulted in a widespread adoption of liquid crystal displays as monitors for television sets, computers, public large screens, and various data output devices. The rapidly growing and changing market sets new tasks for researchers and manufacturers. Growing size of LCD diagonal, which has already exceeded 100 inch size, imposes stronger restrictions onto the quality of the whole device, which means higher requirements to the contrast, color reproduction, and stable gray scale intensity gradation.

The off-axis view issue of LCDs (the off-axis light leakage in the black state leading to the contrast decrease and color inversion at the oblique viewing angles) is a fundamental problem of LCD technology, which is solved by application of optically anisotropic birefringent phase retardation compensation films. Most of the conventional optical compensation elements known in the art represent polymer films that acquire optical anisotropy through mechanical extension. The technology employs such materials as polycarbonate, polyester, polynorbornene, acetyl cellulose etc. Depending on the type of the stress employed on the polymeric film, it is possible to obtain uniaxial or biaxial retardation films of various types. However, the improvement of its performance is difficult due to limitations of the stretching manufacturing process.

Besides the stretching of the amorphous polymeric films, other polymer alignment techniques are known in the art. Thermotropic liquid crystalline polymers (LCP) possess higher birefringence than stretchable polymers described above and provide highly anisotropic films of various types of birefringence. The production of such films comprises coating a polymer melt or solution on a substrate; for the latter case the coating is followed by the solvent evaporation. Examples of the production of the optical films can be found by H. G Rogers and R. A. Caudiana in Journal of Polymer Science: Polymer Chemistry Edition (1985), vol. 23, pp. 2669-2678, and many other patent documents and scientific publications. The general feature of thermotropic LCP processing is that additional alignment actions should be involved, such as an application of the electric field, using of the alignment layer or coating onto a stretched substrate. The after-treatment of the coating is at a temperature at which the polymer exhibits liquid crystalline phase and for a time sufficient for the polymer molecules to be oriented.

Optical films can be also produced by coating of lyotropic liquid crystalline (LLC) solutions based on low-molecular compounds capable of forming columnar supramolecules also known as chromonics. Extensive investigations aimed at developing new methods of fabricating chromonic-based optical films through variation of the film deposition conditions have been described in Yu. A. Bobrov et al., Proc. of the 7^{th} International Conference on Organized Molecular Films (1995), p. 103 and other patent documents and scientific publications. Of particular interest is the development of new compositions of lyotropic liquid crystals utilizing modifying, stabilizing, surfactant and/or other additives in the known compositions, which improve the characteristics of the films, such as (but not limited to) those described by A. Geivandov et al. in Proc. of IDW (2008), pp. 739-742 and S.-K. Park et al. in Advanced Functional Materials (2011), 21(11), pp. 2129-2139. The above referenced technology provides films where the molecules of chromonics are packed with their minimal polarizability axis parallel to the film coating direction, which structure corresponds to O-type polarizers and retardation films of uniaxial—A-plate or biaxial B_{A}-plate types.

Number of rigid-rod, water-soluble polymers are described by N. Sarkar and D. Kershner in Journal of Applied Polymer Science (1996), vol. 62, pp. 393-408. New sulfonated water soluble aromatic polyamides, polyureas, and polyimides were prepared via interfacial or solution polymerization of sulfonated aromatic diamines with aromatic dianhydrides, diacid chlorides, or phosgene. Some of these polymers had sufficiently high molecular weight (<200,000), extremely high intrinsic viscosity (˜65 dL/g), and appeared to transform into a helical coil in salt solution. These polymers have been evaluated in applications such as thickening of aqueous solutions, flocculation and dispersion stabilization of particulate materials, and membrane separation utilizing cast films.

Synthesis and solution properties of some rigid-chain, water-soluble polymers are described by E. J. Vandenberg et al in Journal of Polymer Science: Part A: Polymer Chemistry (1989), vol. 27, pp. 3745-3757. Poly[N, N′-(sulfo-p-phenyl-ene)terephthalamide] (PPT-S) and Poly[N, N′-(sulfo-p-phenylene) pyromellitimide] (PIM-S) are reported to form viscous gel-like solutions at low concentrations (˜0.4 wt. %), although relatively low molecular weight (for example, ca. 5000 for PPT-S) was estimated from the viscosity data. The solutions are highly birefringent, exhibit circular dichroism properties, and are viscosity-sensitive to salt. Some meta- and para-isomeric analogs of PPT-S were prepared; these polymers have similar properties except they are more soluble in water, and higher concentrations are required to obtain significant viscosity.

Self-assembling properties of sulfonated poly-paraphenylene terephthalamides were considered as a function of number and relative position of sulfonic groups to the main chain by E. Mendes, S. Viale, and S. J. Picken in Proc. Symp. on Functional Polymer Materials (2004). The authors report that when the repeated unit contains only one sulfonic group, the structure of the aqueous solutions varies from gel in case of poly(sulfo-paraphenylene terephtalamide) to supramolecular nematic liquid crystal in case of poly(paraphenylene sulfoterephthalamide). Thus position of the sulfonic group affects a structure of the solutions. When two sulfonic groups are present in the repeating unit (in case of poly(sulfo-paraphenylene sulfoterephthalamide)), a molecular polyelectrolyte lyotropic liquid crystal is formed.

The present invention enables production of high-birefringent phase retardation films based on technology of coating of lyotropic liquid crystalline polymer from aqueous solution. This approach allows taking advantages of coating technology for producing of high performance high birefringent optical films of positive A-type free of limitations inherent to the conventional stretching process.

### SUMMARY OF THE INVENTION

An optical film comprising a substrate having front and rear surfaces, and at least one solid optical retardation layer on the front surface of the substrate, wherein the solid optical retardation layer comprises organic rigid rod-like macromolecules based on 2,2′-disulfo-4,4′-benzidine terephthalamide or its salt of the general structural formula I

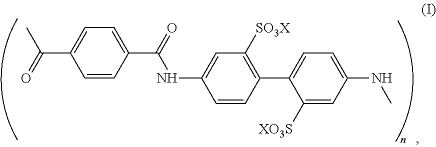

where n is a number of the conjugated organic units in the rigid rod-like macromolecule, which is in the range from 5 to 5000, and X is a counterion selected from a list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Al³⁺, Gd³⁺, Zr⁴⁺ and NH₄₋ₖQₖ⁺, where Q is independently selected from the list comprising linear and branched (C₁-C₂₀) alkyl, (C₂-C₂₀) alkenyl, (C₂-C₂₀) alkinyl, and (C₆-C₂₀)arylalkyl, and k is 0, 1, 2, 3 or 4, and wherein the side-groups SO₃⁻ provide solubility of the organic rigid rod-like polymer macromolecules or its salts in an aqueous solvent and rigidity to the rod-like macromolecule. The solid optical retardation layer is an uniaxial positive A-type layer and is substantially transparent to electromagnetic radiation in the visible spectral range.

### BRIEF DESCRIPTION OF THE DRAWINGS

FIG. 1 schematically shows the cross section of an optical film on a substrate, comprising adhesive and protective layers;

FIG. 2 shows reduced and inherent viscosity measured as a function of poly(2,2′-disulfonyl-4,4′-benzidine terephthalamide) concentration in aqueous solution: [η]=5.1 dl/g; (a) ηₛₚ/C, and (b) ηₗₙ;

FIG. 3 shows a polarizing microscopy image of the lyotropic liquid crystal solution texture of poly(2,2′-disulfonyl-4,4′-benzidine terephthalamide) cesium salt (concentration is equal to 5.6 wt. %);

FIG. 4 shows a polarizing microscopy image of the optical film comprising solid optical retardation layer produced with Mayer rod coating method and comprising poly(2,2′-disulfonyl-4,4′-benzidine terephthalamide);

FIG. 5 shows spectra of the refractive indices of the organic retardation layer prepared from poly(2,2′-disulfonyl-4,4′-benzidine terephthalamide) on a glass substrate: (a) nₓ, and (b) n_{y} and n_{z};

FIG. 6 schematically shows a cross section of the disclosed optical crystal film with an antireflection layer;

FIG. 7 schematically shows a cross section of the disclosed optical crystal film with an additional reflective layer; and

FIG. 8 schematically shows a cross section of the disclosed optical film with a diffuse or specular reflector as the substrate.

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 700 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer.

The term “optically anisotropic retardation layer of positive A-type” refers to an optical layer which refractive indices nₓ, n_{y}, and n_{z} obey the following condition in the visible spectral range: nₓ>n_{y}.=n_{z}.

The term “thickness retardation Rₜₕ” refers to a retardation of a retardation layer, substrate or plate which is defined with the following expression: Rₜₕ=[n_{z}−(nₓ+n_{y})/2]d, where d is a thickness of the retardation layer, substrate or plate.

The term “in-plane retardation Rₒ” refers to a retardation of a retardation layer, substrate or plate which is defined with the following expression: Rₒ=(nₓ−n_{y})d, where d is a thickness of the retardation layer, substrate or plate.

The above mentioned definitions are invariant to rotation of system of coordinates (of the laboratory frame) around of the vertical z-axis for all types of anisotropic layers. As used herein, a “front surface” of a substrate refers to a surface facing a viewer. A “rear surface” refers to the opposite surface of the front surface.

The present invention provides an optical film as disclosed hereinabove. The optical film comprises a substrate having front and rear surfaces. At least one solid retardation layer is provided on the front surface of the substrate. In one embodiment of the optical film, said solid retardation layer is an uniaxial retardation layer possessing two refractive indices (nₓ and n_{y}) corresponding to two mutually perpendicular directions in the plane of the substrate and one refractive index (n_{z}) in the normal direction to the plane of the substrate, wherein the refractive indices obey the following condition: nₓ>n_{y}=n_{z}. The organic rigid rod-like macromolecules are preferentially directed with their long axes being averagely parallel to some direction in the plane of the substrate. In one embodiment said direction coincides with the coating direction. In yet another embodiment of the optical film, the substrate material is selected from the list comprising polymer and glass. A substrate for the optical film may be made of either glass or of a transparent polymer, for example, cellulose acetate. Substrate material may include and not limited to triacetyl cellulose (TAC), polyethylene terephtalate (PET), polyethylene naphtalate (PEN), polyvinyl chloride (PVC), polycarbonate (PC), polypropylene (PP), polyethylene (PE), polycycloolefin (PCO), and polymethyl methacrylate (PMMA).

The substrate may be also optically anisotropic. In addition, the substrate must protect the film from mechanical damage; this requirement determines the substrate thickness and strength.

In some embodiment of the present invention, the disclosed optical film further comprises at least one additional layer—an interlayer formed between the substrate and the solid optical retardation layer. In one embodiment of the optical film, the surface of the interlayer facing the solid optical retardation layer is hydrophilic. In another embodiment of the optical film, the surface of the interlayer facing the solid optical retardation layer bears a relief. In yet another embodiment of the optical film, the surface of the interlayer facing the solid optical retardation layer possesses a texture.

In still another embodiment of the optical film, the interlayer is a planarization layer between the substrate and the solid optical retardation layer.

In one embodiment of the optical film, the rear surface of the substrate is further covered with an antireflection or antiflashing coating.

In one embodiment of the present invention, the disclosed optical film further comprises an additional adhesive transparent layer formed on the solid optical retardation layer.

In another embodiment of the present invention, the disclosed optical film further comprises a protective layer formed on the adhesive layer.

In one embodiment of the optical film, the substrate is a specular or diffusive reflector. In another embodiment of the optical film, the substrate is a specular or diffusive transflector. In yet another embodiment of the optical film, the substrate is a reflective polarizer. In still another embodiment of the optical film, the substrate transmission is not less than 90% in the visible range. In yet another embodiment of the optical film, the polymer substrate material is selected from the list comprising triacetyl cellulose (TAC), polyethylene terephtalate (PET), polyethylene naphtalate (PEN), polyvinyl chloride (PVC), polycarbonate (PC), polypropylene (PP), polyethylene (PE), polycycloolefin (PCO), and polymethyl methacrylate (PMMA).

In some embodiment of the optical film, a substrate is characterized by a substantially negligible in-plane retardation Rₒ and by a thickness retardation Rₜₕ which is in the range from −45 nm to −1200 nm. In one embodiment of the optical film, an in-plane retardation Rₒ of the solid optical retardation layer is not less than 10 nm. In another embodiment of the optical film, an in-plane retardation Rₒ of the solid optical retardation layer is in the range from 10 nm to 750 nm

In order that the invention may be more readily understood, reference is made to the following examples, which are intended to be illustrative of the invention, but are not intended to be limiting the scope.

### Example 1

This example describes synthesis of poly(2,2′-disulfo-4,4′-benzidine terephthalamide) in the form of cesium salt.

1.377 g (0.004 mol) of 4,4′-diaminobiphenyl-2,2′-disulfonic acid was mixed with 1.2 g (0.008 mol) of CsOH and 40 ml of water and stirred with a dispersing stirrer until dissolved. 0.672 g (0.008 mol) of sodium bicarbonate was added to the solution and stirred. While stirring the obtained solution at high speed (2500 rpm) the solution of 0.812 g (0.004 mol) of terephthaloyl dichloride in dried toluene (15 mL) was gradually added within 5 minutes. The stirring was continued for 5 more minutes, and a viscous white emulsion was formed. Then the emulsion was diluted with 40 ml of water, and stirring speed was reduced to 100 rpm. After the reaction mass has been homogenized the polymer was precipitated via adding 250 ml of acetone. Fibrous sediment was filtered and dried.

Gel permeation chromatography (GPC) analysis of the sample was performed with Hewlett-Packard 1050 chromatograph with diode array detector (λ=230 nm), using Varian GPC software Cirrus 3.2 and TOSOH Bioscience TSKgel G5000 PW_{XL} column and 0.2 M phosphate buffer (pH=7) as the mobile phase. Poly(para-styrenesulfonic acid) sodium salt was used as GPC standard. The number average molecular weight Mn, weight average molecular weight Mw, and polydispersity P were found as 3.9×10⁵, 1.7×10⁶, and 4.4 respectively.

### Example 2

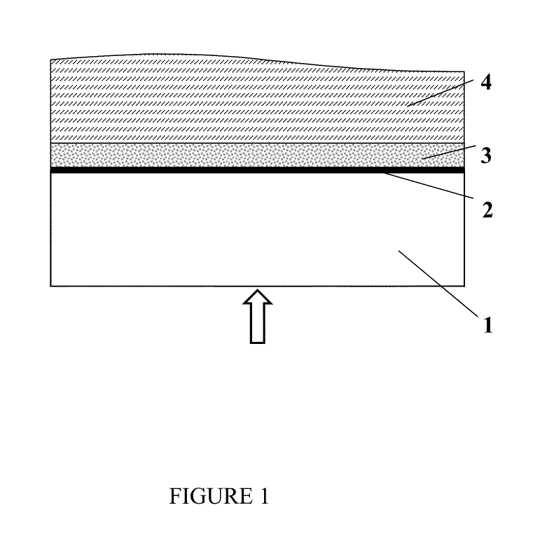

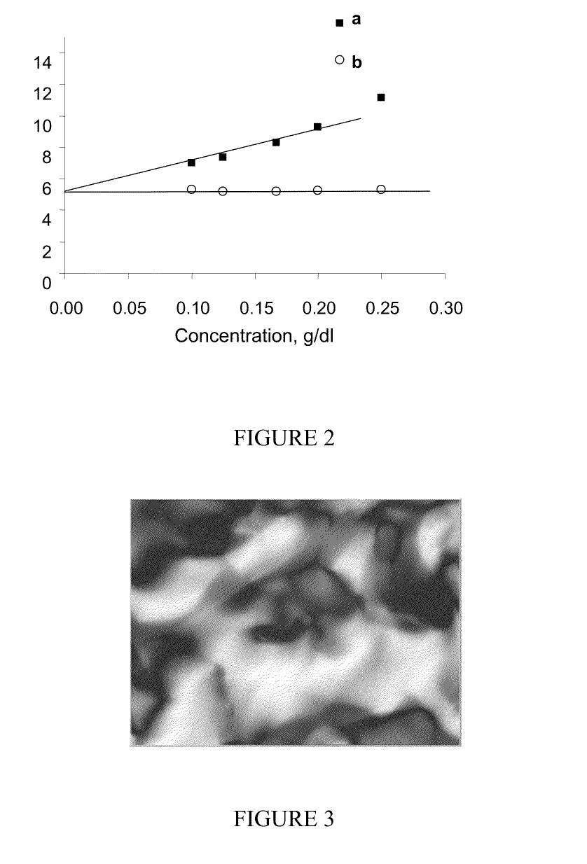

This example describes preparation of the organic optical film using a lyotropic liquid crystal solution. Poly(2,2′-disulfonyl-4,4′-benzidine terephthalamide) was synthesized as described in Example 1. The polymer was synthesized in a Cs-form. Reduced and inherent viscosity was measured as a function of polymer concentration in aqueous solution containing 0.1N NaCl (measurements performed at 25° C.) (see FIG. 1). Intrinsic viscosity was found equal to 5.1 dl/g—this indicates a high molecular weight of the product along with a self-assembling in aqueous solution at low concentration: phase transition concentration was C=4.5 wt %. Lyotropic liquid crystal solution (see FIG. 2) was prepared according to the following procedure: 1% water solution was prepared, filtered from mechanical admixtures, and concentrated to approximately 5.6 wt. % via evaporation.

Fisherbrand microscope glass slides were prepared for coating by soaking in a 10% NaOH solution for 30 min, rinsing with deionized water, and drying in airflow with the compressor. At temperature of 23° C. and a relative humidity of 50% the obtained solution was applied onto the glass plate surface with a Mayer rod #4 moved at a linear velocity of 100 mm/s. The liquid layer of the solution was dried at the same humidity and temperature. The produced optical film comprising a solid retardation layer of thickness of −180 nm is shown in FIG. 3. An x-axis indicates a coating direction.

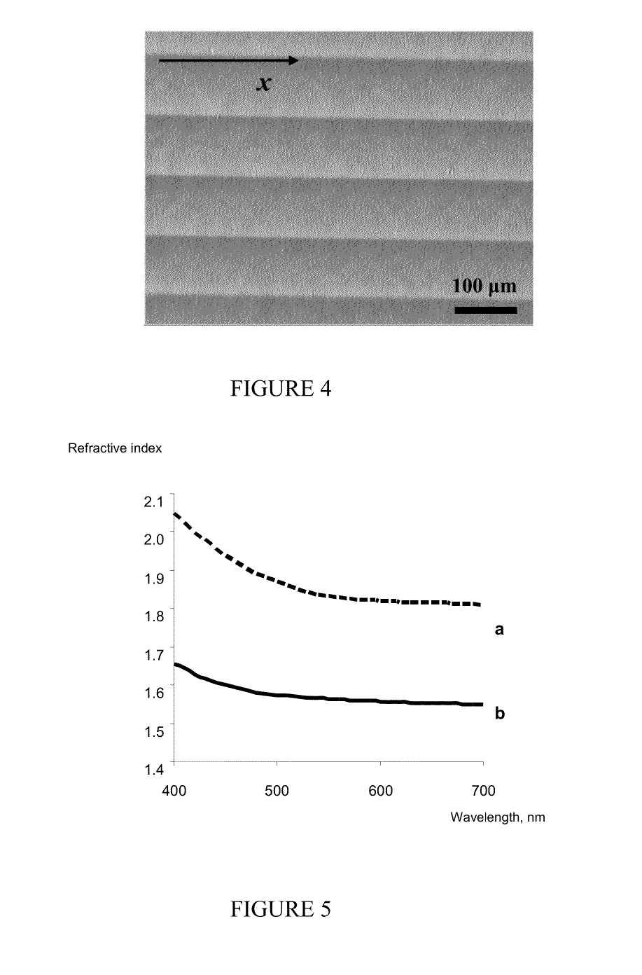

In order to determine the optical characteristics of the solid retardation layer, the optical transmission and reflection spectra were measured in a wavelength range from approximately 400 to approximately 700 nm using a Cary 500 Scan spectrophotometer. Optical transmission of the solid retardation layer was measured using light beams linearly polarized parallel and perpendicular to the coating direction (Tₚₐᵣ, and Tₚₑᵣ, respectively), propagating in direction perpendicular to the retardation layer plane. Optical reflection was measured using S-polarized light propagating at an angle of 12 degrees to the normal of the retardation layer plane and polarized parallel and perpendicular to the coating direction (Rₚₐᵣ and Rₚₑᵣ, respectively). Phase retardation of the samples was measured at incident angles 0, 30, 45 and 60 degrees using Axometrics Mueller Matrix polarimeter. The obtained data were used to calculate the refractive indices (nₓ, n_{y}, and n_{z}) presented in FIG. 4. The obtained solid retardation layer was anisotropic in the plane parallel to the substrate surface (nₓ=1.83, n_{y}=1.55, n_{z}=1.55 at wavelength λ=550 nm).

### Example 3

This example describes preparation of the organic optical film from a lyotropic liquid crystal solution using a reverse gravure coating technique. Lyotropic liquid crystal solution of poly(2,2′-disulfonyl-4,4′-benzidine terephthalamide) sodium salt was prepared with the same procedure as described in Example 1. Concentration of solids was 7.6 wt. %.

Triacetyl cellulose (TAC) was prepared for coating by applying a hydrophilic primer layer. Lyotropic liquid crystal solution was applied onto the TAC plate surface using Reverse Gravure coater at a temperature of 23° C. and relative humidity of 50%. Cylinder #28 was used for coating; which is tri-helical with continuous grooves at 45° approximately 100 microns in size. Linear velocity was 1016 mm/s, and the gravure speed was 160% of that. The liquid coating was dried at 100 degrees C.

The prepared optical film was characterized with a physical thickness of −500 nm and in-plane optical retardation R, of 147 nm at the wavelength of 550 nm, which means the birefringence Δn_{xy} at 550 nm approximately equals to 0.29. Slow axis of the optical retardation film was off from the coating direction by 15 degrees.

### Example 4

The example describes an optical film formed on a substrate 1 as shown in FIG. 5. The film comprises an optical retardation layer 2, an adhesive layer 3, and a protective layer 4. The substrate 1 is made of triacetyl cellulose (TAC). TAC used can be from any manufacturer available on the market, including for example, Optimax, TacBright, or IPI. The substrate thickness is 35 to 200 um; refractive index is n=1.5. The layer 2 is a solid optical retardation layer of positive A-type described in Example 2. The polymer layer 4 protects the optical layer from damage in the course of transportation of the optical film. This optical film is a semi-product, which can be used as a retarder for different applications, for example in liquid crystal displays. Upon removal of the protective layer 4, the film is applied onto the LCD glass with use of adhesive layer 3.

### Example 5

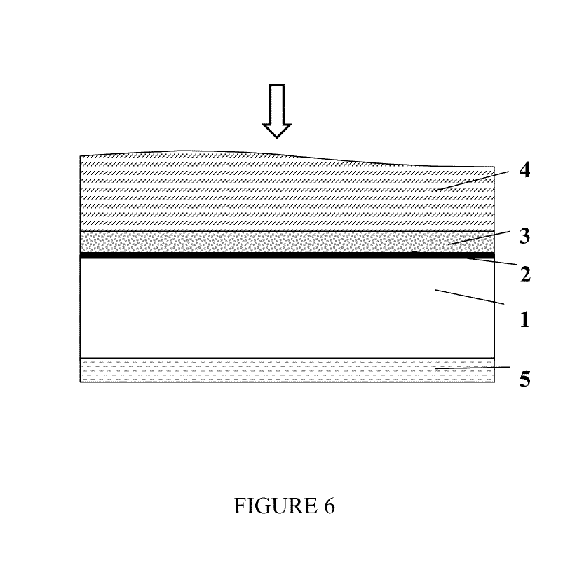

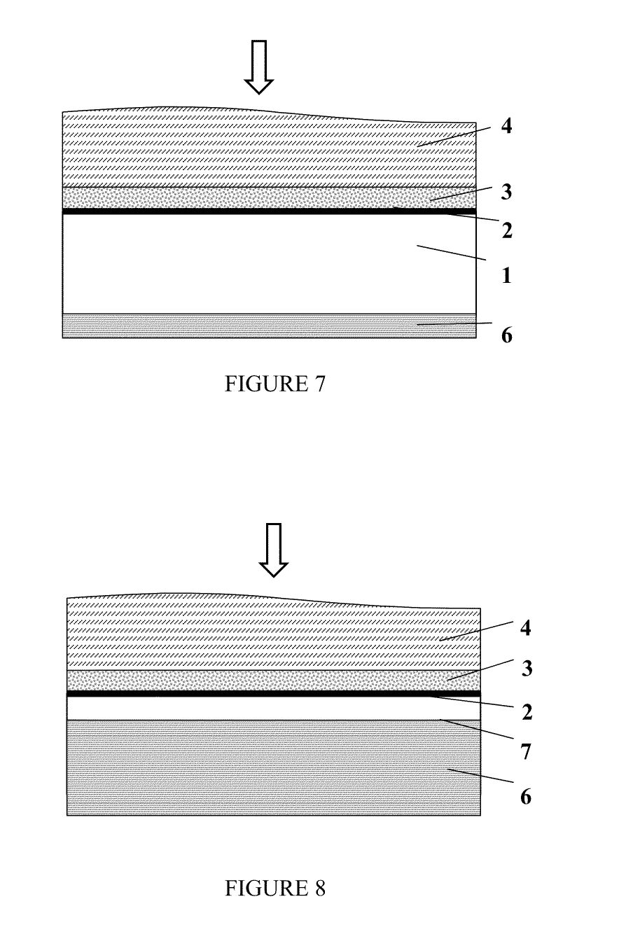

The optical film described in Example 4 may comprise an antireflection layer 5 formed on the substrate as shown in FIG. 6. For example, an antireflection layer 5 made of silicon dioxide SiO2 reduces by 30% the fraction of light reflected from the front surface. A reflective layer 6 may be formed on the substrate, see FIG. 7. The reflective layer can be obtained, for example, by depositing an aluminum film or by any other technique used in the art. The film can then be used for example in a reflective LCD.

### Example 6

The example describes an optical film wherein the optical retardation layer 2 is applied to a diffusive or specular reflector 6 which serves as a substrate (FIG. 8). The reflector 6 could be covered with a planarization layer 7. Polyurethane or acrylic or any other planarization layer can be used for this purpose.

While certain preferred embodiments of the invention have been specifically disclosed, it should be understood that the invention is not limited thereto as many variations will be readily apparent to those skilled in the art and the invention is to be given its broadest possible interpretation within the terms of the following claims.

1. An optical film comprising:
a substrate having front and rear surfaces, and
at least one solid optical retardation layer on the front surface of the substrate, wherein the solid optical retardation layer comprises
organic rigid rod-like macromolecules based on 2,2′-disulfo-4,4′-benzidine terephthalamide or its salt of the general structural formula I 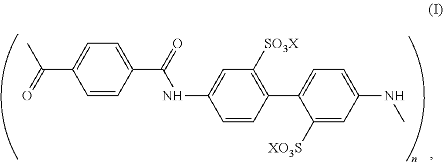
where n is a number of the conjugated organic units in the rigid rod-like macromolecule,
which is in the range from 5 to 5000, and
X is a counterion selected from a list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Al³⁺, Gd³⁺, Zr⁴⁺ and NH₄₋ₖQₖ⁺, where Q is independently selected from the list comprising linear and branched (C1-C20) alkyl, (C2-C20) alkenyl, (C2-C20) alkinyl, and (C6-C20)arylalkyl, and k is 0, 1, 2, 3or 4,
wherein the side-groups SO₃⁻ provide solubility of the organic rigid rod-like polymer macromolecules or its salts in an aqueous solvent and rigidity to the rod-like macromolecule;
wherein the solid optical retardation layer is an uniaxial positive A-type layer and is substantially transparent to electromagnetic radiation in the visible spectral range.

2. An optical film according to any of claim 1, wherein said solid retardation layer is an uniaxial retardation layer possessing two refractive indices (n_{z} and n_{y}) corresponding to two mutually perpendicular directions in the plane of the substrate and one refractive index (n_{z}) in the normal direction to the plane of the substrate, wherein the refractive indices obey the following condition: n, >n_{y}=n_{z}.

3. An optical film according to any of claim 1, wherein the substrate material is selected from the list comprising polymer and glass.

4. An optical film according to any of claim 1, further comprising at least one interlayer formed between the substrate and the solid optical retardation layer.

5. An optical film according to claim 4, wherein a surface of the interlayer facing the solid optical retardation layer is hydrophilic.

6. An optical film according to claim 4, wherein a surface of the interlayer facing the solid optical retardation layer bears a relief.

7. An optical film according to claim 4, wherein a surface of the interlayer facing the solid optical retardation layer possesses a texture.

8. An optical film according to claim 4, wherein the interlayer is a planarization layer between the substrate and the solid optical retardation layer.

9. An optical film according to any of claim 1, wherein the rear surface of the substrate is further covered with an antireflection or antiflashing coating.

10. An optical film according to any of claim 1, further comprising an adhesive transparent layer formed on the solid optical retardation layer.

11. An optical film according to claim 10, further comprising a protective layer formed on the adhesive layer.

12. An optical film according to claim 1, wherein the substrate is a specular or diffusive reflector.

13. An optical film according to any of claim 1, wherein the substrate is a specular or diffusive transflector.

14. An optical film according to any of claim 1, wherein the substrate is a reflective polarizer.

15. An optical film according to any of claim 1, wherein the substrate transmission is not less than 90% in the visible range.

16. An optical film according to any of claim 1, wherein the substrate material is selected from the list comprising triacetyl cellulose (TAC), polyethylene terephtalate (PET), polyethylene naphtalate (PEN), polyvinyl chloride (PVC), polycarbonate (PC), polypropylene (PP), polyethylene (PE), polycycloolefin (PCO), and polymethyl methacrylate (PMMA).

17. An optical film according to claim 16, wherein the substrate is characterized by a substantially negligible in-plane retardation Rₒ and by a thickness retardation Rₜₕ which is in the range from −45 nm to −1200 nm.

18. An optical film according to claim 17, wherein an in-plane retardation Rₒ of the solid optical retardation layer is not less than 10 nm.

19. An optical film according to claim 18, wherein an in-plane retardation Rₒ of the solid optical retardation layer is in the range from 10 nm to 750 nm.
